(19) United States
(12) Patent Application Publication
(10) Pub. No.: US 2021/0307353 A1
(43) Pub. Date: Oct. 7, 2021

(54) PROCESS FOR REDUCING TEMPERING TIME FOR DEPOSITED CONFECTIONERY PRODUCTS

(71) Applicant: WM. WRIGLEY JR. COMPANY, Chicago, IL (US)

(72) Inventor: Jingping LIU, Chicago, IL (US)

(21) Appl. No.: 17/263,014

(22) PCT Filed: Jul. 25, 2019
(86) PCT No.: PCT/US19/43449

§ 371 Date: Jan. 25, 2021

Related U.S. Application Data
(60) Provisional application No. 62/703,533, filed on Jul. 26, 2018.

(51) Int. Cl. A23G 4/04; A23G 4/18; A23G 4/10

(52) U.S. Cl. CPC A23G 4/04; A23G 4/10; A23G 4/184

(57) ABSTRACT

A method is provided for making a molten, deposited confectionery product, such as a chewing gum. In some embodiments, a chewing gum composition containing at least a gum base, flavor and at least two sugar alcohols is mixed by conventional means. The chewing gum composition is then melted and deposited, for example, into a mold formed in a packaging blister. The deposited gum is then heat tempered at an elevated temperature for a period of time. The heat tempering process reduces tempering time required before the deposited chewing gum piece can be cleanly removed from the mold and enjoyed by a consumer. A product of the method also is provided.

### BACKGROUND OF THE INVENTION

The present invention relates to confectionery products, such as chewing gums, which are formed by molding the product in a molten state. In some embodiments, the mold is part of the product packaging.

Chewing gums have been enjoyed by consumers for over a century because they provide flavor and refreshment over an extended time period and satisfy a human urge to chew. A number of forms of chewing gum have been marketed, but the most popular are sticks, tabs and coated pellets. These forms have the advantage of being easily produced in commercial quantities using high-speed forming equipment. However, they can only produce products with limited variations in shape. They cannot produce complex, three dimensional shapes, for example, of animals, fruits or other objects.

Traditional chewing gum forms, such as sticks and tabs, often require a period of tempering, such as 24 to 72 hours at ambient conditions to allow the gum to ‘set up’ and become firm enough for wrapping and packaging. Chilling the gum can accelerate this tempering.

Consumers are constantly looking for new confectionery experiences. Products having three dimensional shapes are attractive and offer opportunities to manufacture products relevant to seasonal or special events. There have been past attempts to mold chewing gums into three dimensional shapes, but such efforts are not known to have ever resulted in commercially successful products.

It has been proposed that a novel consumer product could be prepared by depositing molten confectionery products into a preformed sheet of packaging film which would act as a mold to shape the deposited piece. This could be done as a ‘so-called’ blister pack in which a sheet including a plurality of blister molds is covered with a lidding material (typically a foil or a foil laminate) and then typically further packaged.

One problem with molten confectionery processing is that the products can take a long time to temper, that is, to reach a final, stable texture after forming. While the product may be subjected to further processing, such as conveying and further packaging, after a few minutes of cooling, it may not reach its final, intended texture until weeks or even months after cooling to ambient temperatures (i.e. about 20° C.). Long tempering times may result in the product reaching the consumer before it has tempered and therefore may not provide the optimal intended texture. For example, it may be too soft and/or lack cohesion. In addition, if the product is deposited into a blister of a blister pack, it may be difficult or impossible to cleanly remove the piece from the blister mold without the composition adhering to the mold or distorting as it is removed.

Attempts to reformulate confectionery products to reduce tempering time are likely to lead to products which lack the proper texture or which have shelf stability or other problems.

What is needed is a method of making high quality deposited and molded confectionery products with relatively short tempering times.

### SUMMARY OF THE INVENTION

In one embodiment, the present invention provides a method of producing a confectionery product comprising the steps of:
a. preparing a chewing gum composition comprising at least a gum base, a flavor and at least two sugar alcohols,
b. melting and holding the chewing gum composition at a temperature sufficient to allow depositing the chewing gum composition,
c. depositing the molten chewing gum composition,
d. heat tempering the deposited chewing gum composition at a temperature of at least 25° C. for a total tempering time that is reduced by at least 20% compared to tempering at 20° C.

In some embodiments, heat tempering reduces the tempering time by at least 20% compared to tempering at 20° C. In some embodiments, the tempering time is reduced by at least 30%, or by at least 40%, or by at least 50%, or by at least 60%.

In some embodiments, the confectionery composition is a chewing gum composition that will be heat tempered at a temperature of at least 25° C., at least 30° C., at least 35°, or at least 40° C. In some embodiments, the chewing gum composition will be heat tempered at a temperature within 5° C. lower than the lowest melting point of saturated fats and/or microcrystalline waxes in the chewing gum base.

In some embodiments, the tempering occurs at a relative humidity of less than 50% or less than 35% or less than 20%.

In some embodiments, the composition will be heat tempered for at least 4 hours, at least 6 hours, at least 8 hours, at least 12 hours, at least 24 hours, or at least seven days.

In some embodiments, the composition will be heat tempered for less than 10 days, less than 48 hours, less than 36 hours, less than 24 hours, less than 12 hours, less than 8 hours, less than 6 hours, or less than 5 hours.

In some embodiments, the composition will be heat tempered for a period of between 2 hours and 24 hours, between 4 hours and 24 hours, between 6 hours and 12 hours, between 36 hours and 48 hours, between 2 days and 7 days, between 7 days and 14 days, between 24 hours and 36 hours, between 12 hours and 24 hours, between 8 hours and 12 hours, or between 6 hours and 8 hours.

In some embodiments, the chewing gum will be fully tempered after heat tempering. In some embodiments, the composition will require additional tempering at ambient conditions after heat tempering. In some embodiments, the additional tempering at ambient conditions will be less than three weeks or less than two weeks or less than one week. In some embodiments, the composition will be tempered until the product can be demolded without distortion or deformation.

In some embodiments, the composition would require at least four weeks of tempering at ambient conditions without the heat tempering step. In other embodiments, the composition would require at least eight weeks or at least twelve weeks of tempering at ambient conditions without the heat tempering step.

In some embodiments, the composition will comprise two sugar alcohols or three sugar alcohols. In some embodiments, the composition will comprise at least one alcohol selected from the group consisting of sorbitol, maltitol, xylitol, mannitol, erythritol, isomalt and combinations thereof.

In some embodiments, the composition will comprise a sugar alcohol blend which is a binary blend of xylitol and sorbitol, or xylitol and isomalt, or sorbitol and isomalt, or erythritol and xylitol, with ratio in the range of 1:9 to 9:1, preferably in the range of 1:3 to 3:1 or in the range 1:2 to 2:1.

In some embodiments, the mold into which the composition is deposited is part of the consumer packaging. In some embodiments, the composition is deposited into the blister of a blister pack.

In some embodiments, the composition further comprises at least one ingredient selected from the group consisting of high intensity sweeteners, encapsulated high intensity sweeteners, colors, emulsifiers, fillers, and nutritional supplements.

The present invention further includes products made by any of the above processes.

For non-chewing gum confectionery products (such as a chewy candy, soft candy, or hard candy) and methods, the appropriate ingredients for the desired confectionery product may replace the ingredients specific to chewing gum referenced herein (e.g., gum base).

### BRIEF DESCRIPTION OF THE DRAWINGS

FIG. 1 is a graph of tempering time vs. temperature for 5 mm and 10 mm thick chewing gum pieces and time to achieve minimum acceptable tempering.

FIG. 2 is a graph shows tempering time at 20, 30 and 40° C. to reach fully tempered and minimum acceptable tempered conditions.

FIG. 3 is a graph of enthalpy of the chewing gum of Example 3 after tempering at ambient conditions for 0 to 60 days measured at the center and the surface of the piece.

FIG. 4 is a graph of crust thickness of the chewing gum of Example 3 after tempering for 2 to 15 days at refrigerator, ambient and oven conditions.

FIG. 5 is a graph comparing the crust thickness of the chewing gum of Example 2 after tempering for 2 and 7 days at refrigerator, ambient and oven conditions.

FIGS. 6A-C are photos of bisected chewing gum pieces of Example 3 showing crust formation after 7 days of tempering in refrigerator, ambient and oven conditions.

### DESCRIPTION OF THE INVENTION

The present invention is based on the discovery that deposited molded products actually temper faster when held at an elevated temperature. It is believed that the mechanism of tempering for chewing gum products is the formation of large crystals in the gum mass. In order to form such large crystals, small crystals need to migrate within the gum mass to attach to larger crystals that have already formed (without being bound by theory). (The presence of gum base in the composition limits the temperature at which the composition can be melted due to potential degradation of gum base components.) The ability of the small crystals to migrate, and therefore the tempering speed, is dependent on the viscosity of the mass which, in turn, is dependent on temperature. Thus elevating the temperature of the deposited chewing gum reduces the required tempering time, contrary to what might be expected.

In general, the tempering time decreases logarithmically with temperature up to approximately the temperature of the melting point of saturated fats and/or microcrystalline waxes in the gum base. These fats and waxes typically melt in the range of 50 to 60° C. Thus the heat tempering temperature may be selected to be just below the melting point of the lowest melting fully hydrogenated fat or microcrystalline wax, for example 10° C. lower or 5° C. lower or 3° C. lower or even 1° C. lower than that temperature.

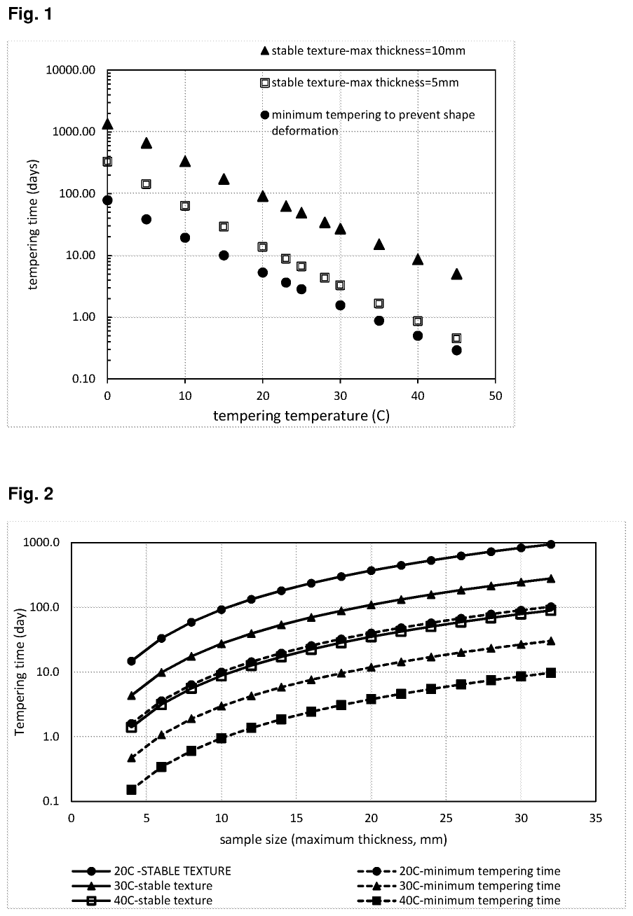

In practice, it is usually not necessary to completely temper the product prior to shipping. This is because the product will continue to temper as it travels through the distribution system. The important thing is that the product be completely or nearly completely tempered by the time the consumer receives it. At a minimum, the product should be sufficiently tempered at that time that it can be easily removed from the package mold without distorting the shape of the product or leaving any visible residue on the mold. The product should also be sufficiently close to its fully tempered texture that it will be acceptable and not noticeably different from the intended final texture. FIG. 1 shows a graph of tempering time versus temperature for 5 mm and 10 mm thick chewing gum pieces and time to achieve minimum acceptable tempering. FIG. 2 shows a graph of tempering time at 20, 30 and 40° C. to reach fully tempered and minimum acceptable tempered conditions.

Thus the heat tempering can be discontinued and the product shipped when it will be fully tempered after tempering at ambient conditions for a period of time compatible with the speed of distribution, such as two weeks, three weeks, four weeks or six weeks.

The completeness of temper can be measured in several ways. A quick test is to simply remove the piece from the mold. A fully tempered product will be easily removable leaving no visible residue on the mold. The demolded piece will exhibit no distortion, deformation or cracks. Pieces that exhibit only minor cracking are close to being fully tempered.

Another method of determining degree of temper is to look at crust thickness. As the product tempers, a crust of tempered material starts to form on the outer surface of the piece and steadily thickens until the entire piece is tempered. This crust can be seen, felt, and measured by cutting the piece in half. A precise method for measuring the crust and thus determining progress in tempering using TMA is described in connection with testing in the examples.

Chewing gums normally comprise a water insoluble gum base portion and a water soluble portion which includes sweeteners, flavors and other ingredients. Any chewing gum base and chewing gum formula may be used in the chewing gums of the present invention.

The water insoluble gum base typically may contain any combination of elastomers, vinyl polymers, elastomer plasticizers, fillers, softeners, waxes and other optional ingredients such as colorants and antioxidants. The variety of gum base ingredients typically used provide the ability to modify the chewing characteristics of gums made from the gum base.

Elastomers provide the rubbery, cohesive nature to the gum which varies depending on this ingredient's chemical structure and how it may be compounded with other ingredients. Natural elastomers may include natural rubber such as smoked or liquid latex and guayule, natural gums such as jelutong, lechi caspi perillo, massaranduba balata, massaranduba chocolate, nispero, rosidinha, chicle, gutta percha, gutta kataiu, niger gutta, tenu, chilte, chiquibul, gutta hang kang. Synthetic elastomers may include high molecular weight elastomers such as butadiene-styrene copolymers and isobutylene-isoprene copolymers. Other polymers which sometimes serve as elastomers include polybutadiene and polyisobutylene, vinyl polymers such as polyvinyl acetate, polyethylene, vinyl copolymeric elastomers such as vinyl acetate/vinyl laurate, vinyl acetate/vinyl stearate, ethylene/vinyl acetate, polyvinyl alcohol or mixtures thereof. These polymers perform best when used in combination with butadiene-styrene copolymers and isobutylene-isoprene copolymers.

Vinyl polymeric and copolymeric type elastomers provide tack resistance, vary the chew characteristics of gums made from these bases and offer hydrophilic properties beneficial to sensory perception of the final gums. For copolymeric types, the amount of vinyl laurate, vinyl stearate, or ethylene present in the vinyl laurate/vinyl acetate (VLNA), vinyl stearate/vinyl acetate (VSNA), or ethylene/vinyl acetate (EVA) copolymers respectively typically ranges from about 10 to about 60 percent by weight of the copolymer. Average molecular weights of these polymers may range from about 2,000 to about 80,000. Ball and ring softening points of these polymers may range from about to 50 to 120° C. Polyvinyl acetate having an average molecular weight from about 8,000 to about 52,000 are preferred for use in the gum base and gum of the present invention. More preferred for chewing gum bases are those of from about 10,000 to about 35,000 molecular weight, and for bubble gum bases, those having from about 30,000 to about 60,000 molecular weight. Vinyl polymers typically release flavor quickly, and using iso-alkanic waxes exhibiting small crystalline structure with these vinyl polymers extends flavor release.

Petroleum waxes aid in the curing of the finished gum made from the gum base as well as improve shelf-life and texture. Wax crystal size when hard also improves the release of flavor. Those waxes high in iso-alkanes have a smaller crystal size than those waxes high in normal-alkanes, especially those with normal-alkanes of carbon numbers less than 30. The smaller crystal size allows slower release of flavor since there is more hindrance of the flavor's escape from this wax versus a wax having larger crystal sizes.

Synthetic waxes are produced by means atypical of petroleum wax production. The synthetic waxes may include waxes containing branched alkanes and copolymerized with monomers such as, but not limited to, propylene and polyethylene and Fischer-Tropsch type waxes. Polyethylene wax is not in the same category as polyethylene, a polymer of ethylene monomers.

Elastomer solvents (sometimes called elastomer plasticizers) vary the firmness of the gum base. Their specificity on elastomer inter-molecular chain breaking (plasticizing) along with their varying softening points cause varying degrees of finished gum firmness when used in base. This is also important when one wishes to provide more elastomeric chain exposure to the alkanic chains of the waxes. Elastomer solvents include natural rosin esters such as glycerol ester of partially hydrogenated rosin, glycerol ester of polymerized rosin, glycerol ester of partially dimerized rosin, glycerol ester of rosin, glycerol ester of tall oil rosin, pentaerythritol esters of partially hydrogenated rosin, partially hydrogenated methyl esters of rosin, pentaerythritol ester of rosin, synthetic elastomer plasticizers such as terpene resins derived from alpha-pinene, beta-pinene and/or d-limonene, and mixtures thereof. The elastomer solvents used may be of one type or of combinations of more than one. Typically, the ratios of one to the other are dependent on each respective softening point, on each effect on flavor release, and on each respective degree of tack they cause to the gum. Ball and ring softening points of the rosin ester types described above may range from about 60 to about 120° C. Softening points of the terpene resins may range from about 60 to about 130° C. and an average molecular weight of from about 500 to 2,000. Occasionally, both terpene and rosin ester resins may be used together.

Softeners modify the texture, cause the hydrophobic and hydrophilic components of the base to be miscible, and may further plasticize the synthetic elastomers of the gum base. Softeners include fully hydrogenated oils of cottonseed, soybean, palm, palm kernel, coconut, safflower and the like, as well as monoglycerides, diglycerides, acetylated monoglycerides, distilled mono- and diglycerides and de-oiled or “powdered” lecithin. The glycerides and lecithin are sometimes referred to as emulsifiers.

Fillers used in gum base modify the texture of the gum base and aid in processing. Fillers include carbonate or precipitated carbonated types such as magnesium and calcium carbonate, ground limestone and silicate types such as magnesium and aluminum silicate, clay, alumina, talc, as well as titanium oxide, mono- di- and tricalcium phosphate, cellulose polymers such as ethyl, methyl and wood or mixtures thereof.

Other optional ingredients such as antioxidants and colorants may also be used in the gum base. Antioxidants prolong shelf-life and storage of gum base, finished gum or their respective components including fats and flavor oils. Antioxidants suitable for use in gum base or gum of the present invention include butylated hydroxyanisole (BHA), butylated hydroxytoluene (BHT), beta-carotenes, tocopherols, acidulants such as Vitamin C, propyl gallate, other synthetic and natural types or mixtures thereof in free-flowing ground or pulverized form.

The soluble portion of chewing gums is composed of flavoring agents (including sensates such as physiological cooling agents, warming agents and tingling agents), bulking agents (also called bulk sweeteners), high intensity sweeteners, colors, acidulants, fillers, emulsifiers, water soluble softening agents and binders.

High-intensity artificial sweeteners can also be used, alone or in combination, with the above. Preferred sweeteners include, but are not limited to, sucralose, aspartame, N-substituted APM derivatives such as neotame, salts of acesulfame, alitame, saccharin and its salts, cyclamic acid and its salts, glycyrrhizin, dihydrochalcones, thaumatin, monellin, stevia and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extrusion may be used to achieve the desired release characteristics.

A variety of flavoring agents can also be used, if desired. The flavor can be used in amounts of about 0.1 to about 15 weight percent of the gum, and preferably, about 0.2% to about 5% by weight. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion. Included in the general category of flavors are sensates, chemicals which impart physiological sensations in the mouth such as cooling agents, warming agents and tingling agents. Examples of cooling agents include menthol, WS-23, WS-3, WS-5, isopulegol, esters of menthol such as menthyl succinate, menthyl lactate and menthyl glutarate, among others. Warming and tingling agents include capsaicin, piperine, jambu and spilanthol.

In the case of non-chewing gum confectionery products, any ingredients typically used in those products may be used in the methods and products of the present invention.

### EXAMPLES

### Examples 1-3

Chewing gum samples were made according to the formulas in Table 1 and the following process.

TABLE 1

| | Example 1 | Example 2 | Example 3 |
|---|---|---|---|
| Sorbitol | 22.21 | 22.72 | 23.02 |
| Xylitol | 44.57 | 45.44 | 45.68 |
| Mannitol | 3.20 | | |
| Gum Base | 26.90 | 24.39 | 24.39 |
| Free and encapsulated high | 2.20 | 2.86 | 2.35 |
| intensity sweeteners | | | |
| HIS | 0.17 | | |
| HIS | 0.29 | | |
| Food acid | | | 0.70 |
| Glycerin | 0.97 | 1.00 | 1.00 |
| Acetylated mono-glycerides | 0.77 | 0.80 | 0.80 |
| Mono-glycerides | | 0.20 | |
| Peppermint flavor | 2.17 | | |
| Spearmint flavor | | 2.57 | |
| Strawberry flavor | | | 2.00 |
| Color | | 0.02 | 0.06 |
| | 100.00 | 100.00 | 100.00 |

The gum base was heated in an oven at 70° C. Once melted, the gum base, powdered sugar alcohols, softeners and humectant were mixed in a Sigma Blade mixer at 55-60° C. until a gum dough was formed. Flavors, high intensity sweeteners and antioxidant were added and mixed until homogeneous, about 14 minutes total. The mixed gum was removed from the mixer. The gum may be optionally sheeted or pelletized at this point. The gum at about 55° C. is introduced into a six zone Clextral BC21 extruder with zone temperature settings according to Table 2.

TABLE 2

| | Processing temperature (° C.) | | | | | | | | |
|---|---|---|---|---|---|---|---|---|---|
| | Zone | Zone | Zone | Zone | Zone | Zone | Zone | | SPEED |
| | 1 | 2 | 3 | 4 | 5 | 6 | 7 | Mold | RPM |
| Ex. 3 | 50 | 55 | 110 | 110 | 110 | 105 | 95 | 77 | 98 |
| Ex. 2 | 50 | 55 | 95 | 95 | 95 | 95 | 95 | 77 | 98 |
| Ex. 1 | 50 | 55 | 95 | 95 | 95 | 95 | 95 | 77 | 98 |

The molten gum was deposited into both silicone molds and PVC blister sheets. Samples in the silicone mold were place inside High Barrier Overwrap (HBO) bags, while the PVC blister was sealed with aluminum foil.

The samples were then aged under three conditions: Refrigerator (3-10° C.), ambient environment (20-23° C., 20% RH), and oven (26-28° C., 44% RH). Samples were pulled at 1, 2, 7, 9, 12, 15, and 30 days for DSC and TMA testing.

### Melting Point and Crystallinity Measurement

A Discovery DSC (Differential Scanning calorimetry) System was operated used to test the samples under the following process:

Sample pan and lid: Tzero pans and Hermetic lids;
Heating rate: 20° C./min;
Cycle: heating-cooling-heating;
Temperature range: −85° C. to 180° C.

Relative Crystallinity=melting enthalpy after melt extrusion/melting enthalpy before melt extrusion(%)

### Crust Thickness Measurement

A Mettler Toledo TMA/SDTA 2+ with intracooler temperature control as used to measure crust thickness according to the following procedure.

A sample was cut in half and a mini wooden spatula was used to carefully remove the soft center portion. The remaining firm crust was cut into a 2×2 mm square. The instrument was operated in isothermal creep test mode at 25° C., 0.02N Load for 5 minutes. This is essentially a method to precisely measure crust thickness.

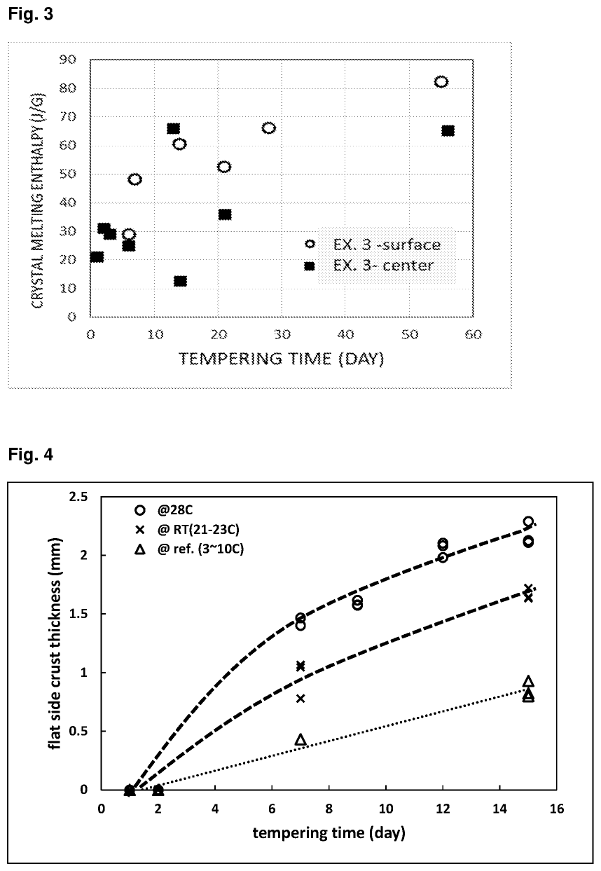

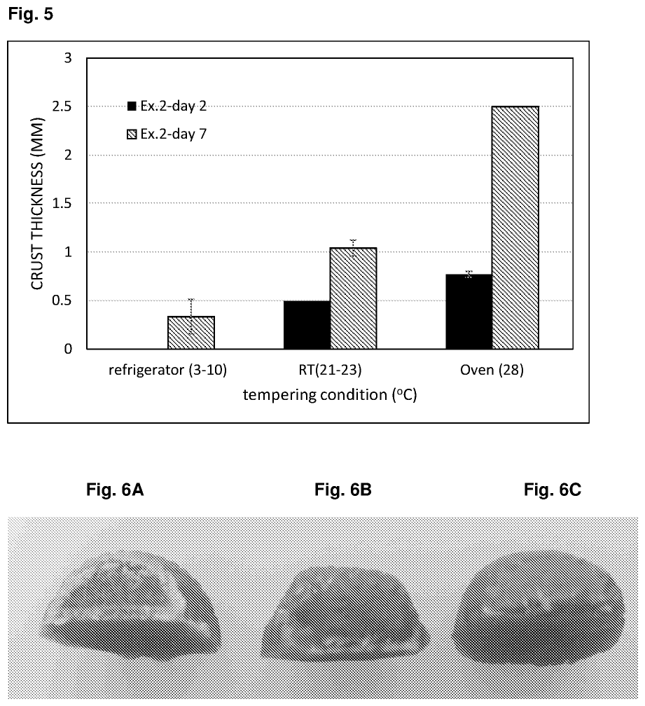

Enthalpy results for Example 3 tempering at ambient conditions (20-22° C.) are shown in FIG. 3. The center material and surface material were tested separately to show faster crystallization at the surface (where the crust begins to form) and the center (which crystallizes last.). FIG. 4 shows a graph of crust thickness of the chewing gum of Example 3 after tempering for 2 to 15 days at refrigerator, ambient and oven conditions. FIG. 5 shows a graph comparing the crust thickness of the chewing gum of Example 2 after tempering for 2 and 7 days at refrigerator, ambient and oven conditions.

TMA measurements of crust thickness of Example 3 are shown in Table 3. As can be seen, the crust thickness was grew 33% faster with heat treatment at 26-28° C. compared to ambient tempering. Photos of the tempered samples (FIG. 6A-C) show the heat treated sample as being essentially completely tempered while the other two samples tempered at refrigerator and ambient conditions are only partially tempered.

TABLE 3

| | Crust thickness (mm) | Cross section |
|---|---|---|
| Tempering condition | (curved side) | photo |
| Refrigerator (3-10° C.), | 0.22 +/− 0.03 | FIG. 6A |
| 7 days | | |
| Ambient (20-22° C.), | 0.96 +/− 0.16 | FIG. 6B |
| 7 days | | |
| Oven (26-28° C.), | 1.28 +/− 0.25 | FIG. 6C |
| 7 days | | |

Crust thickness of Example 1 measured by TMA are shown in Table 4. The samples tempered at refrigerator and ambient conditions for 15 days were demolded with the results described in Table 4. The heat tempered product was demolded at 7 days, but had a thicker crust and no deformation from molding. These results indicate that heat tempering reduced tempering time by more than 50%.

TABLE 4

| | Crust thickness | |
|---|---|---|
| | (mm) | Dimensional stability |
| Tempering condition | (curve side) | after release from blister |
| Refrigerator (3-10° C.) | 0.674 +/− 0.03 | Can be pushed out, but shape |
| 15 days | | distorted, some residue |
| Ambient (20-22° C.) | 1.12 +/− 0.08 | Can be pushed out |
| 15 days | | w/o shape deformation, |
| | | but small surface cracks, |
| | | no residue |
| Oven (26-28° C.) | 1.82 +/− 0.05 | Can be pushed out |
| 7 days | | w/o shape deformation, |
| | | no surface cracks, |
| | | no residue |

### Example 4—Surface Tension Effect

Molten gum samples were deposited on molds made from silicone rubber, polyethylene terephthalate (PET), and aluminum, respectively. All samples were tempered at ambient conditions (20-23° C., 20-40% RH) for a certain period of time, as specified in Table 5. The sample in the silicone mold formed a crust that was thicker than the crust formed on the sample in the PET mold, and the crust formed on the sample in the PET mold was thicker than the crust formed on the sample in the aluminum dish. The sample in the aluminum dish remained sticky and could not be demolded.

TABLE 5

| Sample conditions | Material contacted | Surface energy* | |
|---|---|---|---|
| Ambient (22~23° C., | Silicone mold (curve side) | 18.4-24.4 | mN/m |
| 20-40% RH), | Air (flat side) | | |
| 2.5 months | PET (curve side) | 34-44 | mN/m |
| | Air (flat side) | | |
| | Aluminum dish | 850 | mN/m |

*Literature data, Van Krevelen, D. W. & Nijenhuis, K. te. properties of polymers. Page 235. (Elsevier, 2009); Mark, J. Physical properties of polymers handbook. Page 670 (AIP Press, 1996).

To shorten the tempering time, low surface tension material (for example, less than 35 mN/m, less than 30 mN/m, or less than 25 mN/m) is preferred to be used as the molding device or the coating layer on the surface of the molding device. These materials include but are not limited to aliphatic hydrocarbon polymers or oligomers, aliphatic polyesters or polyethers, silicone, fluoropolymers, such as polytetrafluroethylene, polypropylene, polyethylene, polydimethylsiloxane, polyoxyisobutylene, polyoxypropylene, poly(vinyl octanoate), and combinations thereof.

1. A method of producing a chewing gum product comprising the steps of;
a. preparing a chewing gum composition comprising at least a gum base, a flavor and at least two sugar alcohols,
b. melting and holding the chewing gum composition at a temperature sufficient to allow depositing the chewing gum composition,
c. depositing the molten chewing gum composition,
d. heat tempering the deposited chewing gum composition at a temperature of at least 25° C. for a total tempering time that is reduced by at least 20% compared to tempering at 20° C.

2. The method of claim 1 wherein the total tempering time is reduced by at least 30% compared to tempering at 20° C.

3. The method of claim 1 wherein the total tempering time is reduced by at least 40% compared to tempering at 20° C.

4. The method of claim 1 wherein the total tempering time is reduced by at least 50% compared to tempering at 20° C.

5. The method of claim 1 wherein the total tempering time is reduced by at least 60% compared to tempering at 20° C.

6. The method of claim 1 wherein the total tempering time is less than 24 hours.

7. The method of claim 1 wherein the total tempering time is at least 4 hours.

8. The method of claim 1 wherein the chewing gum composition is heat tempered at a temperature of at least 30° C.

9. The method of claim 1 wherein the chewing gum composition is heat tempered at a temperature of at least 35° C.

10. The method of claim 1 wherein the chewing gum composition is heat tempered at a temperature of at least 40° C.

11. The method of claim 1 wherein the chewing gum is heat tempered at a temperature within 5° C. lower than the lowest melting point of saturated fats and/or microcrystalline waxes in the chewing gum base.

12. The method of claim 1 wherein the tempering occurs at a relative humidity of less than 50%.

13. The method of claim 12 wherein the tempering occurs at a relative humidity of less than 35%.

14. The method of claim 12 wherein the tempering occurs at a relative humidity of less than 20%.

15. The method of claim 1 wherein the chewing gum composition is heat tempered for at least 6 hours.

16. The method of claim 15 wherein the chewing gum composition is heat tempered for at least 8 hours.

17. The method of claim 15 wherein the chewing gum composition is heat tempered for at least 12 hours.

18. The method of claim 15 wherein the chewing gum composition is heat tempered for at least 24 hours.

19. The method of claim 15 wherein the chewing gum composition is heat tempered for at least 7 days.

20. The method of claim 1 wherein the chewing gum is fully tempered after heat tempering.

21. The method of claim 1 wherein the chewing gum requires additional tempering at ambient conditions after heat tempering.

22. The method of claim 1 wherein the chewing gum requires tempering at ambient conditions for less than three weeks after heat tempering.

23. The method of claim 1 wherein the chewing gum requires tempering at ambient conditions for less than two weeks after heat tempering.

24. The method of claim 1 wherein the chewing gum requires tempering at ambient conditions for less than one week after heat tempering.

25. The method of claim 1 wherein the chewing gum requires tempering at ambient until the chewing gum piece can be demolded without distortion or deformation.

26. The method of claim 1 wherein the chewing gum composition comprises two sugar alcohols.

27. The method of claim 1 wherein the chewing gum composition comprises three sugar alcohols.

28. The method of claim 1 wherein the chewing gum composition comprises at least one alcohol selected from the group consisting of sorbitol, maltitol, xylitol, mannitol, erythritol, isomalt and combinations thereof.

29. The method of claim 1 wherein the chewing gum composition comprises a sugar alcohol blend which is a binary blend of xylitol and sorbitol.

30. The method of claim 1 wherein the chewing gum composition comprises a sugar alcohol blend which is a binary blend of xylitol and isomalt.

31. The method of claim 1 wherein the chewing gum composition comprises a sugar alcohol blend which is a binary blend of sorbitol and isomalt.

32. The method of claim 1 wherein the chewing gum composition comprises a sugar alcohol blend which is a binary blend of erythritol and xylitol.

33. The method of claim 1 wherein the two sugar alcohols are present in a ratio in the range of 1:9 to 9:1.

34. The method of claim 1 wherein the two sugar alcohols are present in a ratio in the range of 1:3 to 3:1.

35. The method of claim 1 wherein the two sugar alcohols are present in a ratio in the range of 1:2 to 2:1.

36. The method of claim 1 wherein the surface onto which the molten chewing gum composition is deposited is a conveyor belt.

37. The method of claim 1 wherein the surface onto which the molten chewing gum composition is deposited is a mold.

38. The method of claim 36 wherein the mold into which the chewing gum composition is deposited is part of the consumer packaging.

39. The method of claim 37 wherein the mold into which the chewing gum composition is deposited is the blister of a blister pack.

40. The method of claim 1 wherein the chewing gum composition comprises at least one ingredient selected from the group consisting of high intensity sweeteners, encapsulated high intensity sweeteners, colors, emulsifiers, fillers, nutritional supplements and combinations thereof.

41. The product of the method of claim 1.
